(19) United States
(12) Patent Application Publication
(10) Pub. No.: US 2017/0111937 A1
(43) Pub. Date: Apr. 20, 2017

(54) PAIRING CONNECTION METHOD FOR DEVICES

(71) Applicant: NATIONAL CHIAO TUNG UNIVERSITY, HSINCHU CITY (TW)

(72) Inventors: JYH-CHENG CHEN, HSINCHU CITY 30065 (TW); CHUN CHIEN, TAIPEI CITY 10676 (TW)

(21) Appl. No.: 15/281,869

(22) Filed: Sep. 30, 2016

(30) Foreign Application Priority Data
Oct. 15, 2015 (TW) 104133786

(51) Int. Cl. H04W 76/02; H04W 72/04; H04W 8/24; H04W 72/02

(52) U.S. Cl. CPC H04W 76/02; H04W 72/02; H04W 72/0453; H04W 8/24; H04W 4/008

(57) ABSTRACT

A pairing connection method for devices utilizes frequency to transmit information from a source device to a target device. Firstly, the frequency range of a transmitted acoustic signal is defined. The source device then divides the acoustic signal into a plurality of spectrum sections based on the length of the information, and the information per unit length is placed in the corresponding spectrum section, and a speaker is used to send out the transmitted acoustic signal. After the target device receives the transmitted acoustic signal, the target device retrieves the information from transmission frequency of the spectrum sections and establishes a connection with the source device.

This application claims priority for Taiwan patent application no. 104133786 filed on Oct. 15, 2015, the content of which is incorporated by reference in its entirely.

### BACKGROUND OF THE INVENTION

Field of the Invention

The present invention relates to a data transmission technology, particularly to a pairing connection method for devices.

Description of the Related Art

When a device transmits data to another device, short distance wireless communication is used to establish a connection between the devices. A pairing activity is usually performed before establishing a connection. Both sides can transmit data after the pairing activity. Take Bluetooth as an example. The pairing activity includes steps sequentially performed: manually turn on Bluetooth; search names of devices; select paired objects; and input a common pairing code. Finally, a connection between the paired objects is established. For users, the whole operation process is not intuitive enough and comprises several steps. The connection between the devices has to been established after teaching, especially for the users that firstly use Bluetooth or have bad abilities to learn. The above-mentioned transmission method is not friendly.

Besides, near field communication (NFC) is the set of protocols that enable electronic devices to establish radio communication with each other by touching the devices together, or bringing them into proximity to a distance of typically 10 cm or less, and that apply to Easy cards, entrance guard cards, entrance tickets and bus tickets. Although NFC is a Device-to-Device (D2D) transmission technique with higher acceptance, NFC devices are not popular in the market due to hardware limitation. NFC devices only apply to advanced mobile phones and have unfavorable market share.

In addition, an acoustic transmission technology can be used. A device sends out an acoustic signal which is provided to another device for sensing, pairing and connecting, and then uses acoustic signals with different frequency to transmit data. However, due to congenital limitation, the amounts of data carried by the acoustic transmission technology are usually less than the amounts of data carried by other technologies. The lower the frequency is, the smaller the amounts of data the acoustic transmission technology carries. The acoustic transmission technology has to use check bytes to identify due to its lower safety. Since the amounts of data carried by the acoustic transmission technology are not sufficient, it costs a lot of time finishing acoustic transmission. As a result, the acoustic transmission technology is not practical.

To overcome the abovementioned problems, the present invention provides a pairing connection method for devices, so as to solve the afore-mentioned problems of the prior art.

### SUMMARY OF THE INVENTION

A primary objective of the present invention is to provide a pairing connection method for devices, which uses acoustic frequency to encode and send out the data transmitted, and which establishes a connection with a target device after the target device receives the acoustic signal.

Another objective of the present invention is to provide a pairing connection method for devices, which requires simple equipment such as speakers and microphones to establish a connection between two devices without installing additional hardware on the devices.

A further objective of the present invention is to provide a pairing connection method for devices, which uses acoustic frequency to establish a connection with another device without complicated configuration.

To achieve the abovementioned objectives, the present invention provides a pairing connection method for devices which utilizes frequency to transmit information from a source device to a target device. Firstly, a frequency range of a transmitted acoustic signal is defined. Then, the source device divides the transmitted acoustic signal into a plurality of spectrum sections based on the length of the information, and each spectrum section is divided into a plurality of transmission frequencies, and the information per unit length is placed in the corresponding spectrum section. Then, the source device uses a speaker to send out the transmitted acoustic signal. Then, the target device receives the transmitted acoustic signal to retrieve the information from the transmission frequencies of the spectrum sections. Finally, the target device establishes a connection with the source device.

Below, the embodiments are described in detail in cooperation with the drawings to make easily understood the technical contents, characteristics and accomplishments of the present invention.

### BRIEF DESCRIPTION OF THE DRAWINGS

FIG. 1 is a flowchart showing a pairing connection method for devices according to an embodiment of the present invention;

FIG. 2 is a diagram showing the spectrum division of an acoustic signal according to the present invention; and

FIG. 3 is a diagram showing the spectrum division of an acoustic signal according to an embodiment of the present invention.

### DETAILED DESCRIPTION OF THE INVENTION

The pairing connection method for devices of the present invention applies to two electronic devices such as mobile phones or tablet computers. The electronic devices pair and establish a wireless connection therebetween using an acoustic signal.

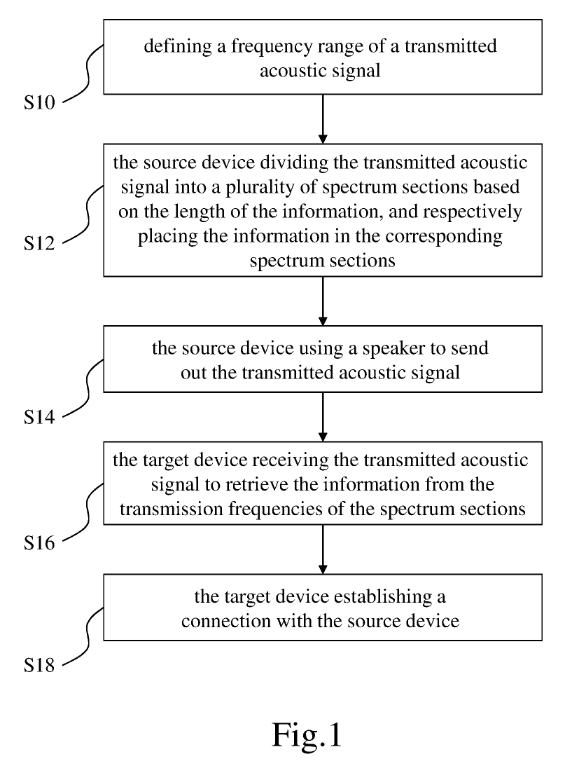

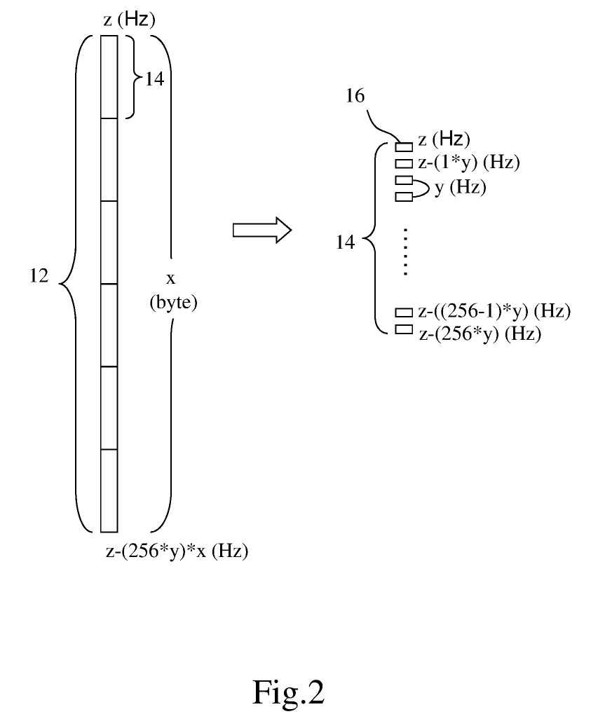

FIG. 1 is a flowchart showing a pairing connection method for devices according to an embodiment of the present invention. FIG. 2 is a diagram showing the spectrum division of an acoustic signal according to the present invention. Refer to FIG. 1 and FIG. 2. In Step S10, a frequency range of a transmitted acoustic signal is defined. The range of acoustic frequency that human ear can hear is within 20 kHz˜22 kHz, and equals the frequency range of many user-oriented devices (such as smart phones or tablet computers) that can make and receive sound. However, these devices not necessarily make or receive sound with too high or too low frequency, and sound with intermediate frequency is easily influenced by background noise. As a result, the frequency is chosen between a range that speakers and microphones can transmit. Besides, the lower the frequency is, the smaller the amounts of data it can carry. The frequency range of the transmitted acoustic signal is perfectly to be chosen to have an upper limit of 22 kHz. Much noise appears when sound is modulated to below 16 kHz. Thus, the transmitted acoustic signal perfectly has a frequency range of within 16 kHz˜22 kHz.

In Step S12, the source device divides the frequency range 12 of the transmitted acoustic signal into a plurality of spectrum sections 14 based on the length of the information, and each spectrum section 14 is divided into a plurality of transmission frequencies 16, and the information per unit length is placed in the corresponding spectrum section 14. x denotes the length (the amount of byte) of the information transmitted, and y denotes every interval of the transmission frequencies, and z denotes an upper limit of the frequency band of the transmitted acoustic signal, and each byte represents the values of the 256 transmission frequencies. Accordingly, the baseband of the nth byte differs from that of (n+1)th byte by 256*y Hz. A lower limit of the frequency band of the transmitted acoustic signal is z−(256*y)*x.

Then, Step S14 is undertaken. In Step S14, the source device is provided with a speaker used to send out the transmitted acoustic signal comprising the information. After receiving the transmitted acoustic signal, the target device retrieves the information from the transmission frequencies 16 of the spectrum sections 14, as shown by Step S16. Finally, in Step 18, the target device establishes a connection with the source device.

The transmitted information of the present invention is the configuration information of the source device, such as media access control address (MAC address). The target device pairs with and connects with the source device after receiving the MAC address of the source device.

In addition, after the target device completely receives the information, the target device returns a transmission success message to the source device. Using the encoded techniques from the present invention, the transmission success message is transmitted to the source device through the acoustic signal, so as to tell the source device the fact that target device has completely received the information. Then, the source device and the target device establish a connection therebetween.

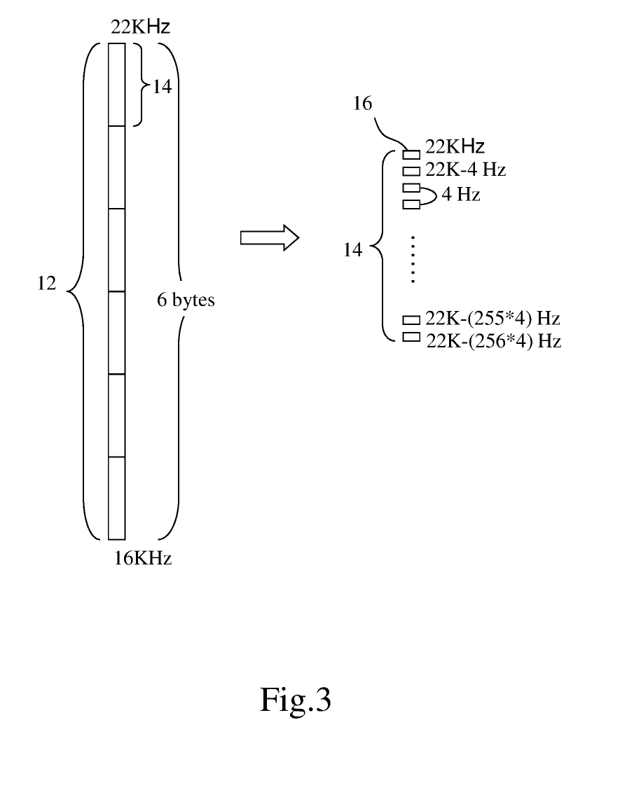

FIG. 3 is a diagram showing the spectrum division of an acoustic signal according to an embodiment of the present invention. Suppose that the length of the information transmitted is 6 bytes, and that every interval of the transmission frequencies is 4 Hz, and that an upper limit of the frequency band of the transmitted acoustic signal is 22 kHz, and that the baseband of the nth byte differs from that of (n+1)th byte by 256*4=1000 Hz, and that a lower limit of the frequency band of the transmitted acoustic signal is 22 k−(256*4)*6 Hz=16 kHz. As a result, the transmitted acoustic signal has a frequency range of within 16 kHz˜22 kHz. The frequency range is divided into 6 spectrum sections 14. Each spectrum section 14 has 1000 Hz and corresponds to one byte. The information of each byte is placed in one spectrum section 14, and the information of each bit is placed in one transmission frequency 16. For example, the information of the first byte is placed in the range of between 22 kHz˜21 kHz [(22 k−(256*4)]=21 k, and the information of the second byte is placed in the range of between 21 kHz˜20 kHz. Therefore, when every interval of the transmission frequencies is 4 Hz, the information has the maximum length of 6 bytes.

Since the target device does not know how many data the source device utilizes frequency to transmit, a preamble signal of one byte is added to synchronize both sides. Alternatively, when the length of the information exceeds the frequency range of the transmitted acoustic signal, the information is divided into a plurality of parts, and a preamble signal of one unit length is sequentially added to the front of each part according to an order of the parts. On the other hand, one byte is added to reorder the divided parts whereby the target device can combine the divided parts according to a serial number. Hence, the preamble signal comprises a serial number, a length of the information or the encoded techniques. Since the one byte added occupies the small frequency band of the transmitted acoustic signal, the transmitted information is divided into at least two parts and the preamble signal can also comprises a serial number, a length of the information or the encoded techniques.

The present invention does not utilize the traditional error retransmission mechanism (when receiving errors, the target device asks the source device to transmit again). This is based on the following two reasons: (1) acoustic transmission is easy to be affected by environments, and (2) we only transmit few data with fast transmission speed. Since the transmitted data (for example, MAC Address) might corrupt during transmission, the present invention provides three ways to perform error recovery when the target device receives these data. Assuming the source device sends out a composite wave consisting of six-bit data with six different frequencies and identical tone to the target device according to the way shown in FIG. 2. The same composite wave will be sent many times. The target device stores the composite waves received in a queue in first in first out way. The target device then decodes the composite waves in the queue in first in first out way, so as to obtain the six-bit data forming the first composite wave, 2^{nd} composite wave, 3^{rd} composite wave, and so on. If there is no error during transmission, all of the six-bit data must be the same. Therefore, all the composite waves received in the queue of the target device are the same as the composite waves sent by the source device. If an error occurs when transmitting the data, there are the following three ways recovering the error:

1. The target device endlessly decodes the transmitted acoustic signal received. Thus, there are a lot of data decoded. The decoded result is selected as the correct result if it appears more than N times. For example, suppose that the source device transmits a MAC Address of “01:02:01:02:FF:FF”. When the target device obtains the first decoded result of “00:00:01:02:FF:FF”, it is arguable whether the result will be correct due to only one result. As a result, the target device continuously decodes the data. When the target device obtains the second decoded result of “01:02:01:02:FF:FF”, it is still arguable that which one of the results is correct. Accordingly, the data transmitted by the source device is decoded again. Suppose that the target device decodes the data ten times, and that there are four pieces of decoded results of “01:02:01:02:FF:FF”. In other words, the probability that the decoded result of “01:02:01:02:FF:FF” is the highest. Therefore, “01:02:01:02:FF:FF” is selected as a correct result. Alternatively, when the decoded result of “01:02:01:02:FF:FF” is obtained for the fourth time, it is selected as a correct result.

2. Two or more bytes are added to the transmitted data to serve as check bytes. Suppose that the original data is six bytes long. Check bytes of two bytes are added to the original data to form the data of eight bytes. One or more composite waves consisting of the data of eight bytes are sent out at one time (because if the composite waves are sent out at two times, it might be limited by hardware staring speed). After the check bytes are decoded (for example, using ReedSolomon algorithm), the information of the front six bytes is obtained. The check bytes are used to recover the original data corrupted during the transmission.

3. Combine the abovementioned ways. If ReedSolomon algorithm does not correctly decode the check bytes, which means that the check bytes are corrupted, the original data transmitted cannot be obtained. Thus, the data of the first six bytes is stored, and the first error recovering method is used.

The target device samples the spectrum sections 44000 times per second to listen to the transmitted acoustic signal of the source device. In other words, the target device samples the spectrum sections once per 1/44 k second. Owing to repeatedly-transmitted signals of the source device and the preamble signal, there is no harm in sampling the signal with intermediate section of the signal. The target device can continue sampling the spectrum sections until the preamble signal appears. The target device continues sampling the spectrum sections from this preamble signal as a start point of the information until sampling the next preamble signal, which means that the information has been received completely. The target device returns a transmission success message to the source device.

On top of that, after the source device decides the frequency of the data transmitted, the source device synchronously transmits signals at the frequency. Since different frequency does not interfere with each other, the data simultaneously transmitted does not result in disarray. The target device uses microphones to receive the frequency completely, and recovers completeness of the data according to an order of the frequency. The target device receives the data by monitoring each frequency without the preamble signals.

The present invention has a small transmission distance which is difficult for others to eavesdrop, thus provides a level of security. The present invention utilizes frequency to transmit different waveforms. Alternatively, after Wi-Fi or Bluetooth channel is established using the present invention, EAP-TLS or other security protocols can then create a secure channel for authentication or data encryption.

The present invention can cooperates with sensors installed on the device, such as infrared sensors or electric compasses. The sensors are used to trigger on acoustic transmission to automatically establish a connection. For example, a magnet is installed on a travel guide panel. When a user device is close to the travel guide panel, magnetic forces turn on an electric compass in the user device to trigger on acoustic transmission. After completely transmitting the information of the user device by acoustic transmission and establishing a Bluetooth connection, the guide panel promotes guide information to the user device through Bluetooth.

In conclusion, the pairing connection method for devices of the present invention utilizes frequency to establish a transmission channel, and transmits small amounts of data fast and safely without complicated configuration processes. The source device sends out a frequency to pair with and connect with another device. The present invention requires only the existing microphones and speakers instead of special hardware. Therefore, the present invention applies to intelligent devices without the need to upgrade the hardware of the source device and the target device.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A pairing connection method for devices, which utilizes frequency to transmit information from a source device to a target device, and said pairing connection method for devices comprising steps of:
defining a frequency range of a transmitted acoustic signal;
said source device dividing said frequency range of said transmitted acoustic signal into a plurality of spectrum sections based on a length of said information, and each said spectrum section is divided into a plurality of transmission frequencies, and said information per unit length is placed in corresponding said spectrum section;
said source device using a speaker to send out said transmitted acoustic signal;
said target device receiving said transmitted acoustic signal to retrieve said information from said transmission frequencies of said spectrum sections; and
said target device establishing a connection with said source device.

2. The pairing connection method for devices of claim 1, wherein said information comprises a media access control address (MAC Address) of said source device.

3. The pairing connection method for devices of claim 1, wherein a frequency band of said transmitted acoustic signal has an upper limit of 22 kHz.

4. The pairing connection method for devices of claim 1, wherein every frequency interval of said transmission frequencies of said spectrum section is 4 Hz.

5. The pairing connection method for devices of claim 1, wherein said information has a length unit of byte, and 256 said transmission frequencies are included in each said spectrum section.

6. The pairing connection method for devices of claim 1, wherein when said length of said information exceeds said frequency range of said transmitted acoustic signal, said information is divided into a plurality of parts, and a preamble signal is sequentially added to a front of each said part according to an order of said parts.

7. The pairing connection method for devices of claim 6, wherein said preamble signal comprises a serial number, a length of the information or encoded techniques.

8. The pairing connection method for devices of claim 1, wherein said target device samples said spectrum sections 44000 times per second to search said transmitted acoustic signal of said source device.

9. The pairing connection method for devices of claim 1, wherein said target device uses at least one microphone to receive said transmitted acoustic signal.

10. The pairing connection method for devices of claim 1, wherein said source device repeatedly transmits said transmitted acoustic signal until said target device returns a transmission success message.

11. The pairing connection method for devices of claim 1, wherein said source device repeatedly transmits said transmitted acoustic signal until exceeding a preset transmission time.

12. The pairing connection method for devices of claim 1, wherein after said target device completely receives said information, said target device returns a transmission success message to said source device.
